(19) United States
(12) Patent Application Publication
(10) Pub. No.: US 2007/0188473 A1
(43) Pub. Date: Aug. 16, 2007

(54) System and methods for document navigation

(75) Inventor: Majid Anwar, Glasgow (GB)

Correspondence Address: FISH & NEAVE IP GROUP;ROPES & GRAY LLP, ONE INTERNATIONAL PLACE, BOSTON, MA, 02110-2624, US

(73) Assignee: Picsel Research Limited, Glasgow (GB)

(21) Appl. No.: 11/353,386

(22) Filed: Feb. 14, 2006

(51) Int. Cl. G06F 3/041

(52) U.S. Cl. 345/173

(57) ABSTRACT

The application relates to computing devices, computer readable media, and methods for navigating content via a touch screen display having dedicated zones for accepting zooming instructions and scrolling and/or panning commands.

### BACKGROUND OF THE INVENTION

Small computing devices, such as cell phones and personal digital assistants (PDAs) continue to become more complex and offer more functionality. Some devices, such as the TREO™ smartphone, sold by Palm, Inc. of Sunnyvale, Calif., combine cell phone and PDA functionality into a single device. The TREO™ includes a touch sensitive display screen, also referred to as a touch screen display, a QWERTY keyboard, a directional keypad, and additional input buttons. The large number of input options can become overwhelming to some users. Thus, there is a need in the art for a simple, intuitive user interface for small computing devices which allow users to easily navigate content displayed on the device.

### SUMMARY OF THE INVENTION

In one aspect the invention relates to a computing device including an easy to use user interface for navigation content. In one embodiment, the computing device includes a touch screen display as the device's primary display. The device also includes a screen monitor for detecting contact of a pointing tool with the touch screen display and for detecting the location of such a contact on the display screen. The device further includes a user interface for initiating a zoom command in response to the screen monitor detecting contact in a first input region of the touch screen display, and for initiating either a scroll command or a pan command in response to the screen monitor detecting contact with a second input region of the touch screen display. In one embodiment, the first input region includes two zones. One zone corresponds to a zoom-in command and the second zone corresponds to a zoom-out command. The second input region may also include two zones. In one embodiment, one of the zones corresponds to a scroll-up command and the other zone corresponds to a scroll-down command. In an alternative embodiment, one of the two zones in the second input region corresponds to a pan-right command and the other corresponds to a pan left command.

In some embodiments, the screen monitor also detects a direction associated with the contact and assigns a direction parameter to the contact based on the detected direction. In one such embodiment, the user interface module initiates either a zoom-in command or a zoom-out command based on the direction parameter assigned to the contact. In addition, the user interface module may initiate either a scroll-up command or a scroll-down command based on the direction parameter assigned to the contact. Or, the user interface module may initiate a pan-left command or a pan-right command based on the direction parameter assigned to the contact. To keep the user interface simple to use, in one embodiment, the user interface is limited to detecting a set of commands consisting only of zoom-in, zoom-out, scroll-up, and scroll-down. In another embodiment, the user interface is limited to detecting a set of commands consisting only of zoom-in, zoom-out, pan-left, and pan-right. In still another embodiment, the user interface is limited to detecting a set of commands consisting only of zoom-in, zoom-out, scroll-up, scroll-down, pan-left, and pan-right.

The computing device may also include a second input device, other than the primary touch screen display, to accept other user inputs. For example, the device could also include a keypad. The computing device of claim 1, comprising a second input device distinct from the touch screen display.

In a second aspect, the invention relates to a method of document navigation. In one embodiment, the method includes logically dividing a touch sensitive display into a first input region for receiving zoom commands and a second input region for receiving either scroll command or pan commands. Contact by a pointing tool is then detected within one of the first and second input regions on the touch sensitive display screen. As a result, either a zoom command, a scroll command, or a pan command is initiated based on the input region in which the contract was detected. In a third aspect, the invention relates to a computer readable medium encoding instructions for causing a computing device to carry out the above described method. In a fourth aspect, the invention relates to a computing device which can accept scroll, zoom, and pan commands via a touch screen primary display, a screen monitor, and a user interface module. In fifth and sixth aspects, the invention relates to a method, and a computer readable medium encoding instructions for causing a computing device to carry out the method, of document navigation. The method includes logically dividing a touch sensitive display into a first input region for receiving zoom commands, a second input region for receiving either scroll command, and third input region for receiving pan commands. Contact by a pointing tool is then detected within one of the input regions on the touch sensitive display screen. As a result, either a zoom command, a scroll command, or a pan command is initiated based on the input region in which the contract was detected.

### BRIEF DESCRIPTION OF THE DRAWINGS

The foregoing discussion will be understood more readily from the following detailed description of the invention with reference to the following drawings:

FIG. 1 is a block diagram of a computing device according to an illustrative embodiment of the invention;

FIG. 2A is a conceptual diagram of a computing device having a touch screen display dedicated to detecting zooming and scrolling commands according to an illustrative embodiment of the invention;

FIG. 2B is a flow chart of a method of displaying content implemented on the computing device of FIG. 2A, according to an illustrative embodiment of the invention;

FIG. 3 is a conceptual diagram of a computing device having a touch screen display dedicated to detecting zooming and panning commands according to an illustrative embodiment of the invention;

FIG. 4 is a conceptual diagram of a computing device having a touch screen display dedicated to detecting zooming, scrolling, and panning commands according to an illustrative embodiment of the invention;

FIG. 5 is a conceptual diagram of a second computing device having a touch screen display dedicated to detecting zooming and scrolling commands according to an illustrative embodiment of the invention;

FIG. 6 is a conceptual diagram of a second computing device having a touch screen display dedicated to detecting zooming and panning commands according to an illustrative embodiment of the invention; and

FIG. 7 is a conceptual diagram of a second computing device having a touch screen display dedicated to detecting zooming, scrolling, and panning commands according to an illustrative embodiment of the invention.

### DESCRIPTION OF CERTAIN ILLUSTRATIVE EMBODIMENTS

To provide an overall understanding of the invention, certain illustrative embodiments will now be described, including a computing device having a touch screen display dedicated to receiving input of a zoom command and either a scroll command, a pan command or some combination thereof. However, it will be understood by one of ordinary skill in the art that the devices described herein may be adapted and modified as is appropriate for the application being addressed and that the devices described herein may be employed in other suitable applications, and that such other additions and modifications will not depart from the scope hereof.

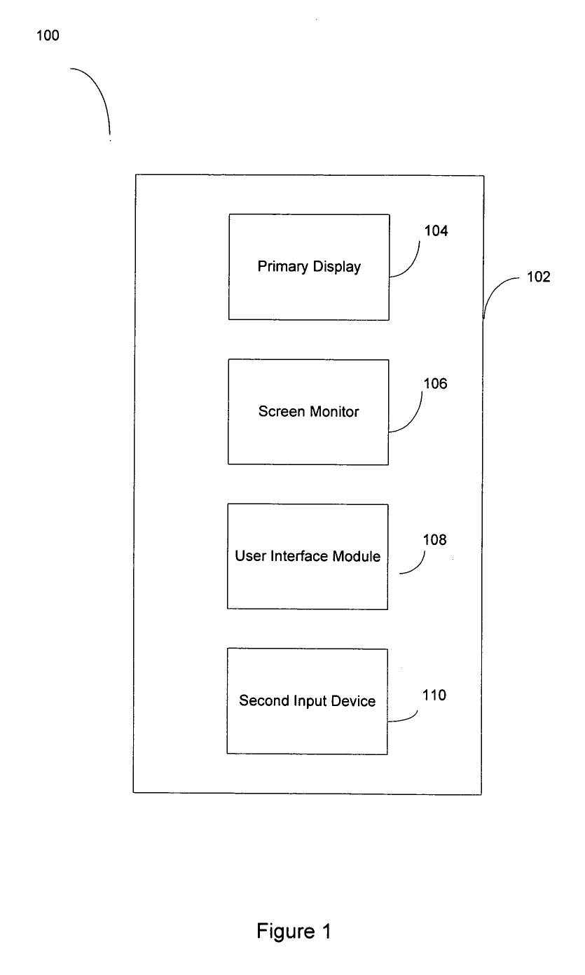

FIG. 1 is a block diagram of a computing device 100, according to an illustrative embodiment of the invention. The computing device can be, for example and without limitation, a cell phone, a laptop computer, a desktop computer, a personal digital assistant, a digital camera, or any other computing device. The computing device 100 includes a processor 102, and a primary display screen 104, a screen monitor 106, and a user interface module 108. The computing device 100 may optionally include a second input device 110.

The processor 102 can be, for example, a central processing unit of a computer, cell phone or PDA, an application specific integrated circuit, or other integrated circuit capable of executing instructions to present and manipulate digital documents. In addition, the processor 102 executes software modules implementing to the screen monitor 106 and the user interface module 108. The screen monitor 106 and/or the user interface module 108 may be implemented in microcode or a high level programming or scripting language, for example, and without limitation, C, C++, JAVA, Flash Scripting Language. Alternatively, the screen monitor 106 and/or the user interface module 108 are implemented as application specific integrated circuits, digital signal processors, or other integrated circuits.

The primary display screen 104 serves both as a primary video display for presenting graphical images, such as digital documents, to users of the computing device 100, and as a user input device. More specifically, the primary display screen 104 is a touch sensitive display providing output to the screen monitor 106. The primary display screen 104 can be a liquid-crystal display, a plasma display, cathode ray tube, or any other display device capable of being adapted to receive touch input.

The screen monitor 106 receives the touch output from the primary display screen 104. In one implementation, the screen monitor 106 is integrated into the primary display screen 104. Based on the touch output, the screen monitor 106 detects contact of a pointing tool with the primary display screen 104. Suitable pointing tools include, for example, a finger, stylus, pen, or other object having an edge, point, or surface which is relatively small in relation to the size of the primary display screen 104. The screen monitor 106, detects at least the location of the contact. The screen monitor 106 may optionally detect the magnitude of pressure applied to the primary display screen 104 in making the contact, the duration of the contact, and, if the location of the contact on the primary display screen 104 varies with time, a direction parameter and a speed parameter corresponding to the variation in contact location. The screen monitor 106 outputs the location, and if detected, the pressure magnitude, duration, and/or the direction parameter of the contact to the user interface module 108.

The user interface module 108 accepts input from the screen monitor 106. Based on the received data, the user interface module 108 identifies one or more user interface commands. More particularly, based on the data output from the screen monitor 106, the user interface module 108 can identify four possible commands depending on the implementation of the computing device 100. The four commands include: zoom-in and zoom-out, and either scroll-up or scroll-down or pan-left or pan-right. Alternatively, the user interface module can identify all six of the commands. In still other alternatives, the user interface module 108 is be able to detect a scroll-up, zoom-in, or pan-right command, but is not able to detect a scroll-down, zoom-out, or pan-left command, or visa versa. In such implementations, once a document is, for example, fully zoomed-in, further zooming-in returns the document to its original scale. The uni-directional scrolling and panning implementations may include similar navigation wrapping features. However, to maintain the intuitiveness and ease of use of the computing device, the user interface module 108 cannot, using the output of the screen monitor 106, detect any command other than the up to six commands selected for the particular implementation.

While the number of commands the user interface modules 108 of the various computing devices is limited, the commands themselves need not be simplistic. For example, in one implementation, the scrolling commands may be page-up and page-down commands. In another implementation, the scrolling commands may also result in a dynamic zooming process, in which the scale of displayed content decreases while a user scrolls through the content, as described in U.S. patent application Ser. No. ______, entitled “Systems And Methods For Navigating Displayed Content” filed Feb. 10, 2006, the entirety of which is herein incorporated by reference. The pan commands may correspond to flipping pages of a book. The zoom commands may result in both a change in scale of displayed content as well as a reflowing of the content displayed on the primary display screen 104, as described in U.S. patent application Ser. No. 11/102,042, entitled “System and Method For Dynamically Zooming and Rearranging Display Items,” the entirety of which is incorporated herein by reference.

The second input device 110 may be a keypad, keyboard, mouse, joystick, or any other input device known to those skilled in the art. Users of the computing device 100 utilize the second input device 110 to initiate commands that cannot be entered by contacting the primary display screen 104 with the pointing tool. For example, the second input device 110 allows a user to enter data, edit data, otherwise manipulate images or initiate or end telephone calls. In other implementations, the computing device 100 optionally includes additional input devices.

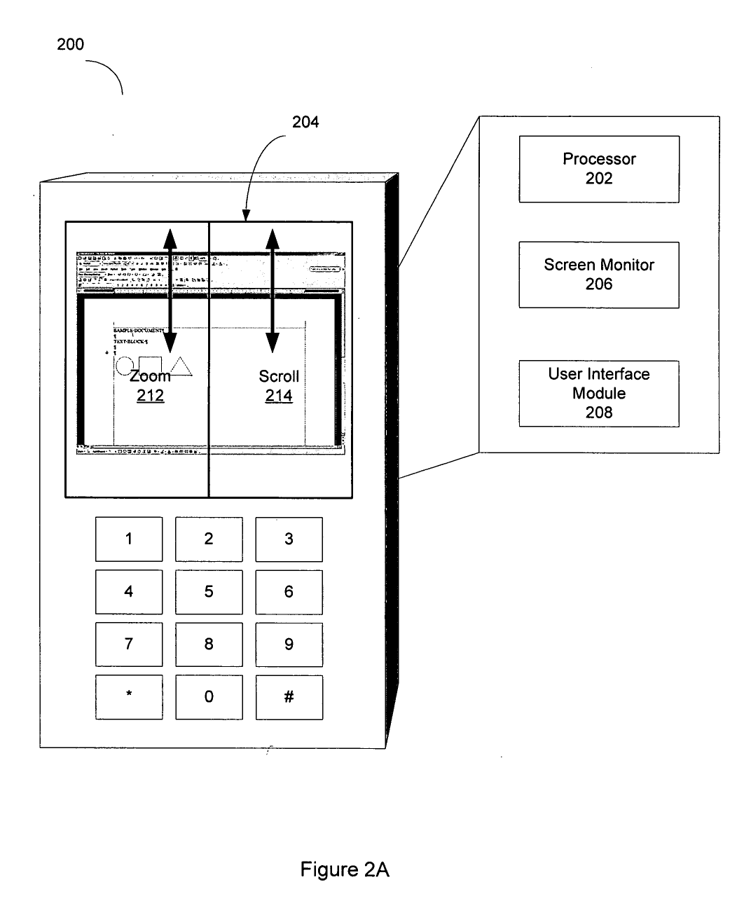

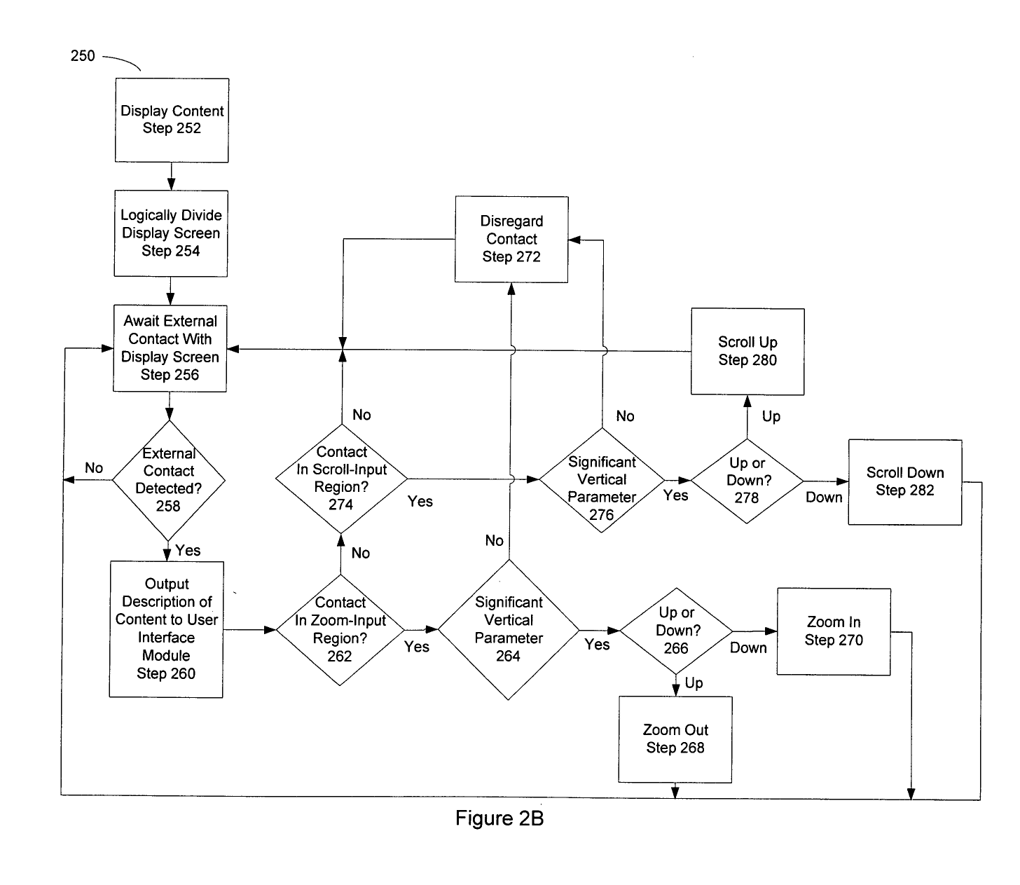

Several implementations of the computing device 100 are described below in relation to FIG. 2 and FIGS. 3-7. The particular user interface command identification methodology used for each implementation is described in relation to each corresponding implementation.

FIG. 2A is a conceptual diagram of a computing device 200 having a touch screen display dedicated to detecting zooming and scrolling commands, according to an illustrative embodiment of the invention. The computing device 200 includes a processor 202, a primary display screen 204, a screen monitor 206, a user interface module 208, and a second input device 210. The primary display screen 204 is a touch screen display. The area of the primary display screen 204 is logically divided into two input regions, a zoom-input region 212 and a scroll-input region 214. The division is logical in that the primary display screen 204 does not need to display any indication of where the zoom-input region 212 or the scroll-input region 214 begin or end, and that the boundaries of the input regions 212 and 214 need not be hardwired into the primary display device 204. For example, the logical division may be encoded in the software implementing the user interface module 208. The solid lines depicted on the primary display screen 204 in FIG. 2A are for illustrative purposes only to indicate the boundaries between the input regions, and may not, in fact be displayed by the computing device 200.

FIG. 2B is a flow chart of a method of displaying content (content display method 250) implemented on the computing device 200 of FIG. 2A, according to an illustrative embodiment of the invention. The content display method 250 begins with computing device 200 displaying content on the primary display screen 204 (step 252). The user interface module 208 of computing device 200 logically divides the display screen (step 254) into the zoom-input region 212 and the scroll-input region 214. The screen monitor then awaits external contact with the primary display screen 204 (step 256). If the screen monitor 206 detects external contact at decision block 258, the screen monitor 206 outputs data describing the contact to the user interface module 208 (step 260). The user interface module 208 then attempts to identify and execute a user command (decision blocks 262, 264, 266, 274, 276 and 278 and steps 268, 270, 280 or 282) based on the output of the screen monitor 206. If the screen monitor 206 does not detect external contact, the screen monitor continues to await external content (step 256).

Upon the user interface module 208 receiving output from the screen monitor 206 indicating detection of an external content, the user interface module analyzes the received output to determines whether the external contact was located in the zoom-input region 212 (decision block 262). If the contact was in the zoom-input region 212, at decision block 264, the user interface module 208 determines whether the contact had a significant vertical parameter. A contact has a vertical direction parameter if the contact on the display screen 204 moved in a vertical direction, for example if a user drew a vertical line. If, at decision block 264, the user interface module 208 determines that the contact had a vertical parameter, the user interface module 208 determines the direction of the vertical parameter at decision block 266. In response to the user interface module 208 determining the external contact had an upwards vertical parameter, the user interface module 208 initiates the execution of a zoom-out command (step 268). In response to the user interface module 208 determining the external contact had a downwards vertical parameter, the user interface module 208 initiates the execution of a zoom-in command (step 270). In response to the external contact in the zoom-input region not having a significant vertical parameter (at decision block 264), the user interface module 208 disregards the external contact and awaits further input from the screen monitor 206 (step 272).

Referring back to decision block 262, in response to the user interface module 208 determining that the external contact was not located in the zoom-input region, the user interface module 208 determines whether the contact was in the scroll-input region 214 (decision block 274). If the detected external contact was in the scroll-input region 214, at decision block 276, the user interface module 208 determines whether the contact had a significant vertical parameter. If, at decision block 276, the user interface module 208 determines that the contact had a vertical parameter, the user interface module 208 determines the direction of the vertical parameter at decision block 278. In response to the user interface module 208 determining the external contact had an upwards vertical parameter, the user interface module 208 initiates the execution of a scroll-up command (step 280). In response to the user interface module 208 determining the external contact had a downwards vertical parameter, the user interface module 208 initiates the execution of a scroll down command (step 282). In response to the external contact in the scroll-input region not having a significant vertical parameter at decision block 276, the user interface module 208 disregards the external contact and awaits further input from the screen monitor 206 (step 272). If, at decision block 274, the detected external contact falls outside the scroll-input region 214, the user interface module 208 disregards the external contact and awaits further input from the screen monitor 206 (step 272). The remaining computing devices 300-700 described below implement similar methods of operation. Such methods are described in relation to each computing device 300-700.

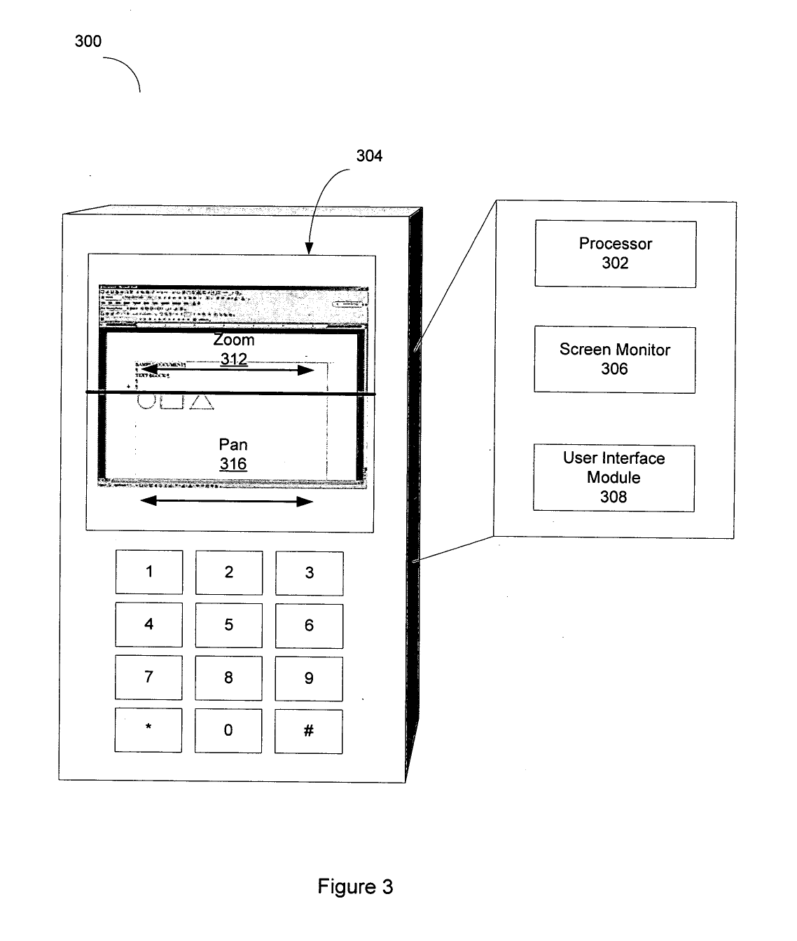

FIG. 3 is a conceptual diagram of a computing device 300 having a touch screen display dedicated to detecting zooming and panning commands, according to an illustrative embodiment of the invention. The computing device 300 includes a processor 302, a primary display screen 304, a screen monitor 306, a user interface module 308, and a second input device 310. The user interface module logically divides the area of the primary display screen 304 into two input regions, a zoom-input region 312 and a pan-input region 316. The division is logical in that the primary display screen 304 does not need to display any indication of where the zoom-input region 312 or the pan-input region 316 begin or end, and that the boundaries of the input regions 312 and 316 need not be hardwired into the primary display device 304. The solid lines on the primary display screen 304 are for illustrative purposes only to indicate the boundaries between the input regions, and may not, in fact be displayed by the computing device 300.

The computing device 300 detects and executes zoom-related commands as follows. The user interface module 308 initiates a zoom command in response to the screen monitor 306 detecting contact of a pointing tool in the zoom-input region 312 of the primary display screen 304 having a horizontal direction parameter. In response to the screen monitor 306 outputting detection of a contact, having an rightwards direction, located in an area of the primary display screen 304 determined by the user interface module 308 to be in the zoom-input region 312, the user interface module 308 initiates a zoom-in command. In response to the screen monitor 306 outputting detection of a contact, having a leftwards direction, located in an area of the primary display screen 304 determined by the user interface module 308 to be in the zoom-input region 312, the user interface module 308 initiates a zoom-out command.

The computing device 300 detects and executes pan-related commands as follows. The user interface module 308 initiates a pan command in response to the screen monitor 306 detecting contact of a pointing tool in the pan-input region 316 of the primary display screen 304 having a horizontal direction parameter. In response to the screen monitor 306 outputting detection of a contact, having an leftwards direction, located in an area of the primary display screen 304 determined by the user interface module 308 to be in the pan-input region 316, the user interface module 308 initiates a pan-left command. In response to the screen monitor 306 outputting detection of a contact, having a rightwards direction, located in an area of the primary display screen 304 determined by the user interface module 308 to be in the pan-input region 316, the user interface module 308 initiates a pan-right command.

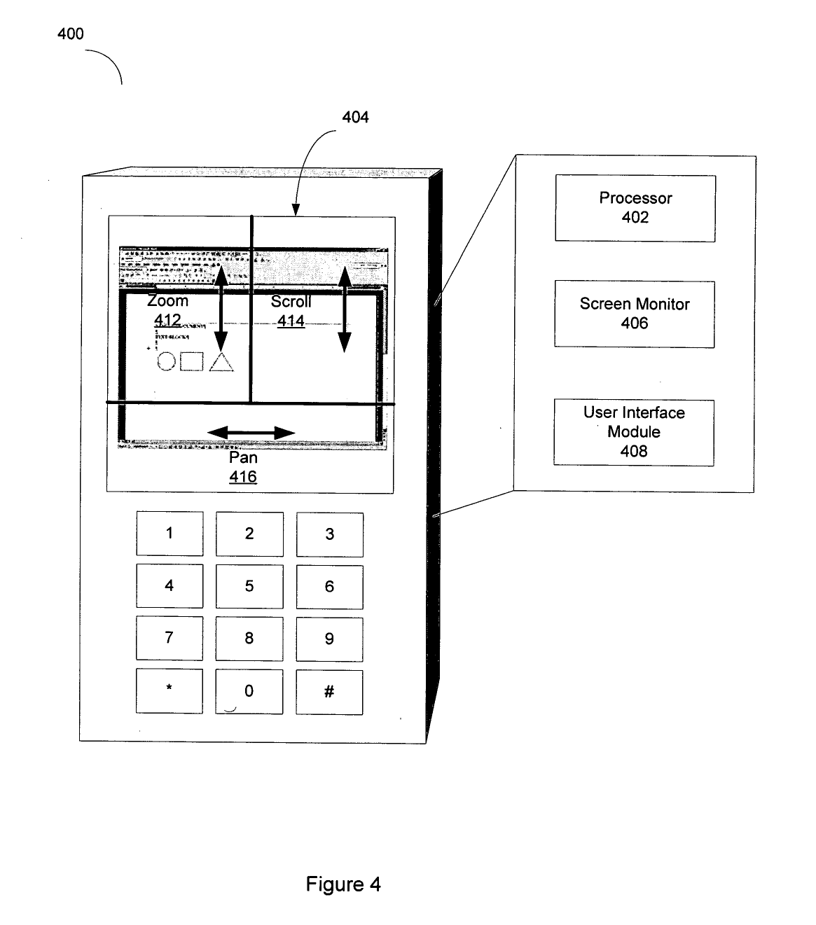

FIG. 4 is a conceptual diagram of a computing device having a touch screen display dedicated to detecting zooming, scrolling, and panning commands according to an illustrative embodiment of the invention. The computing device 400 includes a processor 402, a primary display screen 404, a screen monitor 406, a user interface module 408, and a second input device 410. The user interface module logically divides the area of the primary display screen 404 into three input regions, a zoom-input region 412, a scroll-input region 414, and a pan-input region 416. The division is logical in that the primary display screen 404 does not need to display any indication of where the zoom-input region 412, the scroll-input region 414, or the pan-input region begin or end, and that the boundaries of the input regions 412, 414, and 416 need not be hardwired into the primary display device 204. The solid lines on the primary display screen 404 are for illustrative purposes only to indicate the boundaries between the input regions, and may not, in fact be displayed by the computing device 400.

The computing device 400 detects and executes zoom-related commands as follows. The user interface module 408 initiates a zoom command in response to the screen monitor 406 detecting contact of a pointing tool in the zoom-input region 412 of the primary display screen 404 having a vertical direction parameter. In response to the screen monitor 406 outputting detection of a contact, having an upwards direction, located in an area of the primary display screen 404 determined by the user interface module 408 to be in the zoom-input region 417, the user interface module 408 initiates a zoom-in command. In response to the screen monitor 406 outputting detection of a contact, having a downwards direction, located in an area of the primary display screen 404 determined by the user interface module 408 to be in the zoom-input region 412, the user interface module 408 initiates a zoom-out command.

The computing device 400 detects and executes scroll-related commands as follows. The user interface module 408 initiates a scroll command in response to the screen monitor 406 detecting contact of a pointing tool in the scroll-input region 414 of the primary display screen 404 having a vertical direction parameter. In response to the screen monitor 406 outputting detection of a contact, having an upwards direction, located in an area of the primary display screen 404 determined by the user interface module 408 to be in the scroll-input region 414, the user interface module 408 initiates a scroll-up command. In response to the screen monitor 406 outputting detection of a contact, having a downwards direction, located in an area of the primary display screen 404 determined by the user interface module 408 to be in the scroll-input region 414, the user interface module 408 initiates a scroll-down command.

The computing device 400 detects and executes pan-related commands as follows. The user interface module 408 initiates a pan command in response to the screen monitor 406 detecting contact of a pointing tool in the pan-input region 416 of the primary display screen 404 having a horizontal direction parameter. In response to the screen monitor 406 outputting detection of a contact, having an leftwards direction, located in an area of the primary display screen 404 determined by the user interface module 408 to be in the pan-input region 416, the user interface module 408 initiates a pan-left command. In response to the screen monitor 406 outputting detection of a contact, having a rightwards direction, located in an area of the primary display screen 404 determined by the user interface module 408 to be in the pan-input region 416, the user interface module 408 initiates a pan-right command.

For each of the commands detected by the user interface modules 208, 308, 408 described above, the user-interface module may vary the magnitude or velocity of a zoom, scroll, or pan executed by the computing device based on the magnitude of the pressure applied in making the detected contact and/or on the speed of the variation of location of the detected contact.

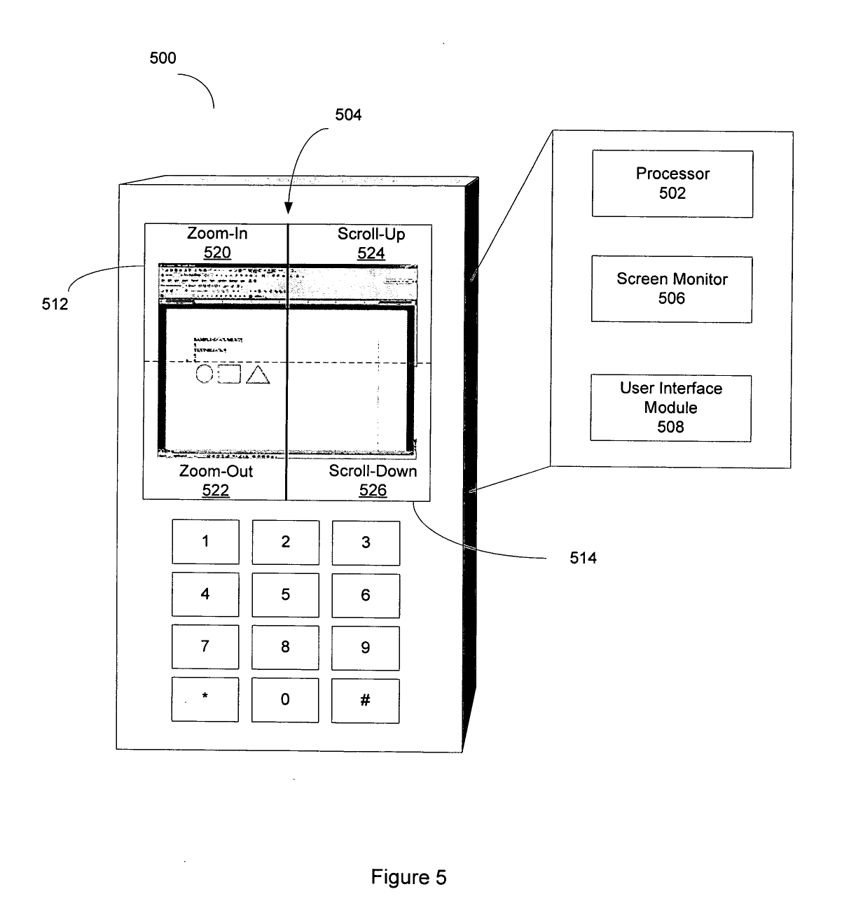

FIG. 5 is a conceptual diagram of a second computing device having a touch screen display dedicated to detecting zooming and scrolling commands according to an illustrative embodiment of the invention. The computing device 500 includes a processor 502, a primary display screen 504, a screen monitor 506, a user interface module 508, and a second input device 510. The primary display screen 508 is a touch screen display. The area of the primary display screen 504 is logically divided into two input regions, a zoom-input region 512 and a scroll-input region 514. Each input region 512 and 514 is further subdivided into two zones. The zoom-input region is subdivided into a zoom-in zone 520 and a zoom-out zone 522. The scroll-input region 514 is subdivided into a scroll-up zone 524 and a scroll-down zone 526. The divisions are logical in that the primary display screen 504 does not need to display any indication of where the input regions 512 or 514 or the zones 520, 522, 524, and 526 begin or end, and that the boundaries of the input regions 512 and 514 and zones 520, 522, 524, and 526 need not be hardwired into the primary display device 504. The solid lines on the primary display screen 504 are for illustrative purposes only to indicate the boundaries between the input regions. The dashed lines indicate the boundaries between the zones within the input regions. These lines need not be displayed by the computing device 500.

The computing device 500 detects and executes zoom-related commands as follows. The user interface module 508 initiates a zoom command in response to the screen monitor 506 detecting contact of a pointing tool in the zoom-input region 512 of the primary display screen 504. In response to the screen monitor 506 outputting detection of a contact located in an area of the primary display screen 504 determined by the user interface module 508 to be in the zoom-in zone 520 of the zoom-input put region 512, the user interface module 508 initiates a zoom-in command. In response to the screen monitor 506 outputting detection of a contact located in an area of the primary display screen 504 determined by the user interface module 508 to be in the zoom-out zone 522 of the zoom-input region 512, the user interface module 508 initiates a zoom-out command.

The computing device 500 detects and executes scroll-related commands as follows. The user interface module 508 initiates a scroll command in response to the screen monitor 506 detecting contact of a pointing tool in the scroll-input region 514 of the primary display screen 504. In response to the screen monitor 506 outputting detection of a contact located in an area of the primary display screen 504 determined by the user interface module 508 to be in the scroll-up zone 524 of the scroll-input put region 514, the user interface module 508 initiates a scroll-up command. In response to the screen monitor 506 outputting detection of a contact located in an area of the primary display screen 504 determined by the user interface module 508 to be in the scroll-down zone 526 of the scroll-input region 514, the user interface module 508 initiates a scroll-down command.

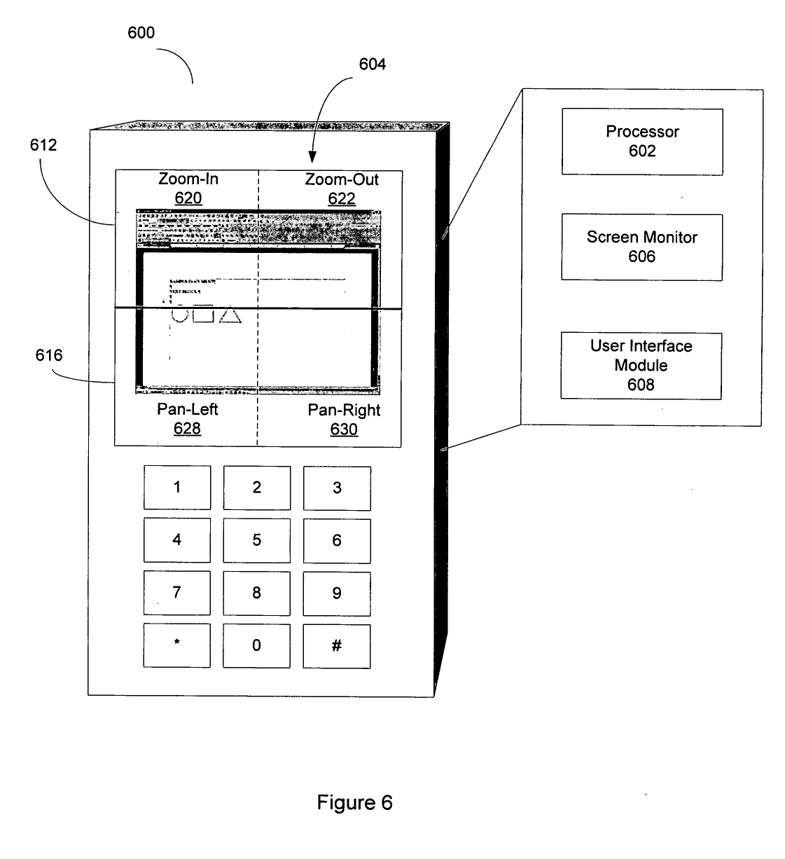

FIG. 6 is a conceptual diagram of a second computing device having a touch screen display dedicated to detecting zooming and panning commands according to an illustrative embodiment of the invention. The computing device 600 includes a processor 602, a primary display screen 604, a screen monitor 606, a user interface module 608, and a second input device 610. The primary display screen 608 is a touch screen display. The area of the primary display screen 604 is logically divided into two input regions, a zoom-input region 612 and a pan-input region 616. Each input region 612 and 616 is further subdivided into two zones. The zoom-input region 612 is subdivided into a zoom-in zone 620 and a zoom-out zone 622. The pan-input region 616 is subdivided into a pan-left zone 628 and a pan-right zone 630. The divisions are logical in that the primary display screen 604 does not need to display any indication of where the input regions 612 or 616 or the zones 620, 622, 628, and 630 begin or end, and that the boundaries of the input regions 612 and 616 and zones 620, 622, 628, and 630 need not be hardwired into the primary display device 604. The solid lines on the primary display screen 604 are for illustrative purposes only to indicate the boundaries between the input regions. The dashed lines indicate the boundaries between the zones within the input regions. These lines need not be displayed by the computing device 600.

The computing device 600 detects and executes zoom-related commands as follows. The user interface module 608 initiates a zoom command in response to the screen monitor 606 detecting contact of a pointing tool in the zoom-input region 612 of the primary display screen 604. In response to the screen monitor 606 outputting detection of a contact located in an area of the primary display screen 604 determined by the user interface module 608 to be in the zoom-in zone 620 of the zoom-input put region 612, the user interface module 608 initiates a zoom-in command. In response to the screen monitor 606 outputting detection of a contact located in an area of the primary display screen 604 determined by the user interface module 608 to be in the zoom-out zone 622 of the zoom-input region 612, the user interface module 608 initiates a zoom-out command.

The user interface module 608 initiates a pan command in response to the screen monitor 606 detecting contact of a pointing tool in the pan-input region 616 of the primary display screen 604. In response to the screen monitor 606 outputting detection of a contact located in an area of the primary display screen 604 determined by the user interface module 608 to be in the pan-left zone 628 of the pan-input put region 616, the user interface module 608 initiates a pan-left command. In response to the screen monitor 606 outputting detection of a contact located in an area of the primary display screen 604 determined by the user interface module 608 to be in the pan-right zone 630 of the pan-input region 616, the user interface module 608 initiates a pan-right command.

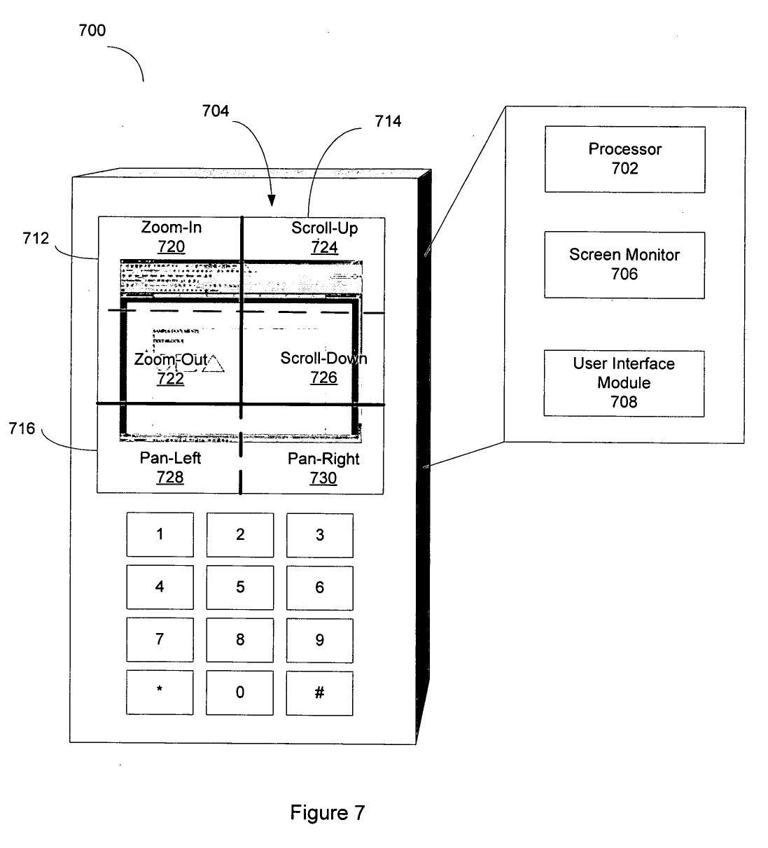

FIG. 7 is a conceptual diagram of a second computing device having a touch screen display dedicated to detecting zooming, scrolling, and panning commands according to an illustrative embodiment of the invention. The computing device 700 includes a processor 702, a primary display screen 704, a screen monitor 706, a user interface module 708, and a second input device 710. The user interface module logically divides the area of the primary display screen 704 into three input regions, a zoom-input region 712, a scroll-input region 714, and a pan-input region 716. Each input region 712, 714, and 716 is further subdivided into two zones. The zoom-input region 712 is subdivided into a zoom-in zone 720 and a zoom-out zone 722. The scroll-input region 714 is subdivided into a scroll-up zone 724 and a scroll-down zone 726. The pan-input region 716 is subdivided into a pan-left zone 728 and a pan-right zone 730. The divisions and subdivisions are logical in that the primary display screen 704 does not need to display any indication of where the zoom-input region 712, the scroll-input region 714, or the pan-input region begin or end, and that the boundaries of the input regions 712, 714, and 716 need not be hardwired into the primary display device 204. The solid lines on the primary display screen 704 are for illustrative purposes only to indicate the boundaries between the input regions. The dashed lines indicate the boundaries between the zones within the input regions. These lines need not be displayed by the computing device 700.

The computing device 700 detects and executes zoom-related commands as follows. In response to the screen monitor 706 outputting detection of a contact located in an area of the primary display screen 704 determined by the user interface module 708 to be in the zoom-in zone 720 of the zoom-input put region 712, the user interface module 708 initiates a zoom-in command. In response to the screen monitor 706 outputting detection of a contact located in an area of the primary display screen 704 determined by the user interface module 708 to be in the zoom-out zone 722 of the zoom-input region 712, the user interface module 708 initiates a zoom-out command.

The computing device 700 detects and executes scroll-related commands as follows. The user interface module 708 initiates a scroll command in response to the screen monitor 706 detecting contact of a pointing tool in the scroll-input region 714 of the primary display screen 704. In response to the screen monitor 706 outputting detection of a contact located in an area of the primary display screen 704 determined by the user interface module 708 to be in the scroll-up zone 724 of the scroll-input put region 714, the user interface module 708 initiates a scroll-up command. In response to the screen monitor 706 outputting detection of a contact located in an area of the primary display screen 704 determined by the user interface module 708 to be in the scroll-down zone 726 of the scroll-input region 714, the user interface module 708 initiates a scroll-down command.

The computing device 700 detects and executes pan-related commands as follows. The user interface module 708 initiates a pan command in response to the screen monitor 706 detecting contact of a pointing tool in the pan-input region 716 of the primary display screen 704. In response to the screen monitor 706 outputting detection of a contact located in an area of the primary display screen 704 determined by the user interface module 708 to be in the pan-left zone 728 of the pan-input put region 716, the user interface module 708 initiates a pan-left command. In response to the screen monitor 706 outputting detection of a contact located in an area of the primary display screen 704 determined by the user interface module 708 to be in the pan-right zone 730 of the pan-input region 716, the user interface module 708 initiates a pan-right command.

For each of the commands detected by the user interface modules 208, 308, 708 described above, the magnitude or velocity of the zoom, scroll, or pan executed by the computing device can be related to the magnitude of the pressure applied in making the detected contact.

The invention may be embodied in other specific forms without departing from the spirit or essential characteristics thereof. The forgoing embodiments are therefore to be considered in all respects illustrative, rather than limiting of the invention.

What is claimed is:

1. A computing device comprising:
a touch screen display serving as a primary display for the computing device;
a screen monitor for detecting contact of a pointing tool with the touch screen display and for detecting the location of the contact on the touch screen; and
a user interface module for initiating a zoom command in response to the screen monitor detecting contact in a first input region of the touch screen display, and for initiating one of a scroll command and a pan command in response to the screen monitor detecting contact with a second input region of the touch screen display.

2. The computing device of claim 1, wherein the first input region comprises a zone corresponding to a zoom-in command and a zone corresponding to a zoom-out command.

3. The computing device of claim 1, wherein the second input region comprises a zone corresponding to a scroll-up command and a zone corresponding to a scroll-down command.

4. The computing device of claim 1, wherein the second input region comprises a zone corresponding to a pan-left command and a zone corresponding to a pan-right command.

5. The computing device of claim 1, wherein the screen monitor detects a direction of movement of the pointing tool contacting the touch screen display and assigns a direction parameter to the contact based on the detected direction.

6. The computing device of claim 5, wherein the user interface module initiates one of a zoom-in command and a zoom-out command based on the direction parameter assigned to the contact.

7. The computing device of claim 5, wherein the user interface module initiates one of a scroll-up command and a scroll-down command based on the direction parameter assigned to the contact.

8. The computing device of claim 5, wherein the user interface module initiates one of a pan-left command and a pan-right command based on the direction parameter assigned to the contact.

9. The computing device of claim 1, wherein the interface module detects and initiates a set of commands from a set of commands consisting only of zoom-in, zoom-out, scroll-up, and scroll-down.

10. The computing device of claim 1, wherein the interface module detects and initiates a set of commands from a set of commands consisting only of zoom-in, zoom-out, pan-left, and pan-right.

11. The computing device of claim 1, wherein the interface module detects and initiates a set of commands from a set of commands consisting only of zoom-in, zoom-out, scroll-up, scroll-down, pan-left, and pan-right.

12. The computing device of claim 1, comprising a second input device distinct from the touch screen display.

13. The computing device of claim 12, wherein the second input device comprises a keypad.

14. A computing device comprising:
a touch screen display serving as a primary display for the computing device;
a screen monitor for detecting contact of a pointing tool with the touch screen display and for detecting the location of the contact on the touch screen;
a user interface module for initiating a zoom command in response to the screen monitor detecting contact in a first input region of the touch screen display, for initiating a scroll command in response to the screen monitor detecting contact with a second input region of the touch screen display, and for initiating a pan command in response to the screen monitor detecting contact with a third input region of the touch screen display.

15. A computer readable medium encoding instructions for performing a method of document navigation, the method comprising:
logically dividing a touch sensitive display into a first input region for receiving zoom commands and a second input region for receiving one of scroll and pan commands;
detecting contact of a pointing tool within one of the first and second input regions on the touch sensitive display screen; and
initiating one of zoom command, a scroll command, and a pan command based on the input region in which the contact was detected.

16. The computer readable medium of claim 15, comprising instructions for dividing the first input region into a zone corresponding to a zoom-in command and a zone corresponding to a zoom-out command.

17. The computer readable medium of claim 15, comprising instructions for dividing the second input region into a zone corresponding to a scroll-up command and a zone corresponding to a scroll-down command.

18. The computer readable medium of claim 15, comprising instructions for dividing the second input region into a zone corresponding to a pan-left command and a zone corresponding to a pan-right command.

19. The computer readable medium of claim 15, comprising instructions for detecting a direction of movement of the pointing tool contacting the touch screen display and for assigning a direction parameter to the contact based on the detected direction.

20. The computer readable medium of claim 19, comprising instructions for initiating one of a zoom-in command and a zoom-out command based on the direction parameter assigned to the contact.

21. The computer readable medium of claim 19, comprising instructions for initiating one of a scroll-up command and a scroll-down command based on the direction parameter assigned to the contact.

22. The computer readable medium of claim 19, comprising instructions for initiating one of a pan-left command and a pan-right command based on the direction parameter assigned to the contact.

23. The computer readable medium of claim 15, comprising instructions for detecting and initiating a set of commands from a set of commands consisting only of zoom-in, zoom-out, scroll-up, and scroll-down.

24. The computer readable medium of claim 15, comprising instructions for detecting and initiating a set of commands from a set of commands consisting only of zoom-in, zoom-out, pan-left, and pan-right.

25. The computer readable medium of claim 15, comprising instructions for detecting and initiating a set of commands from a set of commands consisting only of zoom-in, zoom-out, scroll-up, scroll-down, pan-left, and pan-right.

26. A computer readable medium encoding instructions for performing a method of document navigation, the method comprising:
logically dividing a touch sensitive display into a first input region for receiving zoom commands, a second input region for receiving a scroll, and a third input region for receiving a pan command;
detecting contact of a pointing tool within one of the first, second, and third input regions on the touch sensitive display screen; and
initiating one of zoom command, a scroll command, and a pan command based on the input region in which the contact was detected.

27. A method of document navigation, the method comprising:
logically dividing a touch sensitive display into a first input region for receiving zoom commands and a second input region for receiving one of scroll and pan commands;
detecting contact of a pointing tool within one of the first and second input regions on the touch sensitive display screen; and
initiating one of zoom command, a scroll command, and a pan command based on the input region in which the contact was detected.

28. The method of claim 27, comprising dividing the first input region into a zone corresponding to a zoom-in command and a zone corresponding to a zoom-out command.

29. The method of claim 27, comprising dividing the second input region into a zone corresponding to a scroll-up command and a zone corresponding to a scroll-down command.

30. The method of claim 27, comprising dividing the second input region into a zone corresponding to a pan-left command and a zone corresponding to a pan-right command.

31. The method of claim 27, comprising detecting a direction of movement of the pointing tool contacting the touch screen display and for assigning a direction parameter to the contact based on the detected direction.

32. The method of claim 31, comprising initiating one of a zoom-in command and a zoom-out command based on the direction parameter assigned to the contact.

33. The method of claim 31, comprising initiating one of a scroll-up command and a scroll-down command based on the direction parameter assigned to the contact.

34. The method of claim 31, comprising initiating one of a pan-left command and a pan-right command based on the direction parameter assigned to the contact.

35. The method of claim 27, comprising detecting and initiating a set of commands from a set of commands consisting only of zoom-in, zoom-out, scroll-up, and scroll-down.

36. The method of claim 27, comprising detecting and initiating a set of commands from a set of commands consisting only of zoom-in, zoom-out, pan-left, and pan-right.

37. The method of claim 27, comprising detecting and initiating a set of commands from a set of commands consisting only of zoom-in, zoom-out, scroll-up, scroll-down, pan-left, and pan-right.

38. A method of document navigation, the method comprising:
logically dividing a touch sensitive display into a first input region for receiving zoom commands, a second input region for receiving a scroll, and a third input region for receiving a pan command;
detecting contact of a pointing tool within one of the first, second, and third input regions on the touch sensitive display screen; and
initiating one of zoom command, a scroll command, and a pan command based on the input region in which the contact was detected.
